(19) United States
(12) Patent Application Publication
(10) Pub. No.: US 2022/0252787 A1
(43) Pub. Date: Aug. 11, 2022

(54) DUAL-NESTED CLEAVER

(71) Applicant: COMMSCOPE TECHNOLOGIES LLC, Hickory, NC (US)

(72) Inventors: Mandy Lea TRNKA, Lonsdale, MN (US); Scott L. CARLSON, Bloomington, MN (US); Jaime GONZALEZ BATISTA, Prior Lake, MN (US); Richard S. TIEV, Shakopee, MN (US)

(73) Assignee: COMMSCOPE TECHNOLOGIES LLC, Hickory, NC (US)

(21) Appl. No.: 17/630,464

(22) PCT Filed: Jul. 22, 2020
(86) PCT No.: PCT/US2020/043118

§ 371 Date: Jan. 26, 2022

Related U.S. Application Data
(60) Provisional application No. 62/878,868, filed on Jul. 26, 2019.

(51) Int. Cl. G02B 6/25; G02B 6/255

(52) U.S. Cl. CPC G02B 6/25; G02B 6/2555

(57) ABSTRACT

A fiber cleaving tool includes a cleaving component, a first mounting nest at a first end of the cleaving component, and a second mounting nest at an opposite second end of the cleaving component. Each mounting nest is configured to hold and orient a mounting clip to direct one or more optical fibers towards the cleaving component. The orientation of the mounting nests of the cleaving tool may correspond to the orientation of the mounting nests of a splice tool.

### CROSS-REFERENCE TO RELATED APPLICATION

This application is being filed on Jul. 22, 2020 as a PCT International Patent Application and claims the benefit of U.S. patent application Ser. No. 62/878,868, filed on Jul. 26, 2019, the disclosure of which is incorporated herein by reference in its entirety.

### BACKGROUND

To fusion splice together two sets of one or more optical fibers, the two sets of optical fibers are positioned end-to-end at a splice location. An arc or plasma is generated between probes at the splice location to melt the optical fibers together. Before splicing, the ends of the fibers are prepared. For example, the fibers may be cleaved to form a clean edge. In the case of a mass fusion splice, the optical fibers of each set may be cleaved to a common length.

Using a typical cleaving tool, the first set of fibers are loaded at the cleaving tool and the ends of the fibers are cleaved. The first set of fibers is then mounted at the splice tool. The second set of fibers are then loaded at the cleaving tool in the same orientation that the first set of fibers were loaded. The ends of the fibers of the second set are cleaved. The second set of fibers is then mounted at the splice tool. However, since the fibers are mounted at the splice tool end-to-end, the second set of fibers must be rotated 180 degrees relative to the first set of fibers when positioned at the splice tool. Such rotation can decrease operation efficiency and may require management of the fibers during rotation to avoid breakage.

Improvements are desired.

### SUMMARY

Certain aspects of the disclosure are directed to fiber cleaving tool including a cleaving component, a first mounting nest at a first end of the cleaving component, and a second mounting nest at an opposite second end of the cleaving component.

In certain implementations, each mounting nest is configured to hold and orient a mounting clip to direct one or more optical fibers towards the cleaving component.

In certain implementations, the orientation of the mounting nests of the cleaving tool may correspond to the orientation of the mounting nests of a splice tool.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a first mounting clip holding a set of one or more fibers in a closed position;

FIG. 2 is a top plan view of the first mounting clip of FIG. 1 shown in an open position;

FIG. 3 is a schematic diagram of a workstation including an example splicing tool and an example cleaving tool disposed adjacent each other in a common orientation;

FIG. 4 is a side elevational view of the cleaving tool of FIG. 3 shown schematically, the cleaving tool including first and second mounting nests;

FIG. 5A shows a first mounting clip holding a first set of fibers at the first mounting nest of the cleaving tool of FIG. 4 and a scoring tool marking the first set of fibers;

FIG. 5B shows the first set of fibers of FIG. 5A marked by a score line;

FIG. 5C shows an actuator being depressed along an axis towards the first set of fibers to break the fibers at the score line;

FIG. 6A shows a second mounting clip holding a second set of fibers at the second mounting nest of the cleaving tool of FIG. 4 and a scoring tool marking the second set of fibers;

FIG. 6B shows the second set of fibers of FIG. 6A marked by a score line;

FIG. 6C shows an actuator being depressed along an axis towards the second set of fibers to break the fibers at the score line;

FIG. 7 is a perspective view of an example standard cleaving tool with a nest extension retro-fit thereto suitable for use with the workstation shown in FIG. 3, the nest extension holding a mounting clip holding a second set of fibers;

FIG. 8 is a perspective view of an example nest extension suitable for use with the cleaving tool of FIG. 7;

FIG. 9 is a top plan view of the cleaving tool and nest extension of FIG. 7 shown with a mounting clip and first set of fibers mounted at the first mounting nest; and

FIG. 10 is a perspective view of an example splicing tool suitable for use with the workstation shown in FIG. 3.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

Referring to the figures in general, the present disclosure is directed to a fiber cleaving tool 120 for use in cutting one or more optical fibers 150, 160 to a specified length. In some implementations, the cleaved fiber(s) can then be transferred to a fiber splicing tool 110 for fusion or other splicing to one or more corresponding fibers 160, 150. In other implementations, the cleaved fiber(s) can be inserted within a connector (e.g., a plug connector) to terminate the optical fiber(s).

In some implementations, the same cleaving tool 120 can be used to cleave the ends of both sets of fibers 150, 160 to be spliced at the splicing tool 110. In certain implementations, each set of fibers 150, 160 to be spliced can be mounted within the cleaving tool 120 in the same orientation in which the fibers 150, 160 are mounted within the splicing tool 110. In certain implementations, the splice tool 110 and the cleaving tool 120 can be arranged in alignment with each other at a workstation 100, thereby facilitating transfer of the cleaved fibers from the cleaving tool 120 to the splicing tool 110 as will be described in more detail herein.

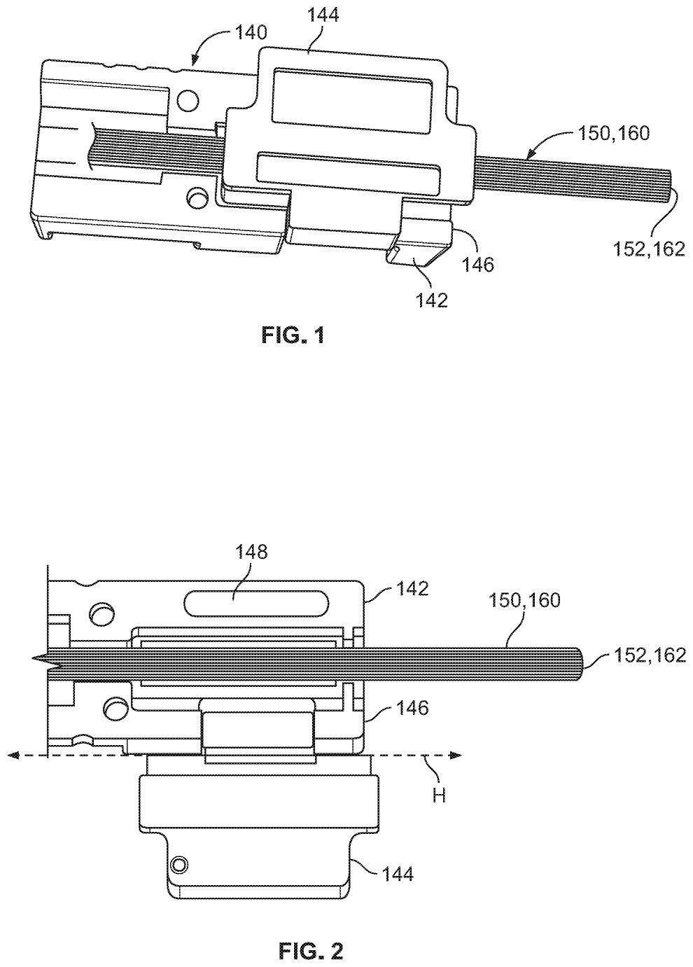

Referring now to FIGS. 1 and 2, each set of one or more fibers 150, 160 to be cleaved is releasably held by a fiber mounting clip 140. The fiber mounting clip 140 is sized and shaped to fit within mounting nests of various tools, including the fiber cleaving tool 120 and the fiber splicing tool 110. Disposing the fiber mounting clip 140 at a mounting nest of a tool positions the fibers 150, 160 held by the mounting clip 140 at a known and repeatable position within the tool.

In certain implementations, a mounting clip 140 includes a base 142 and a cover 144. The base 142 defines a channel in which the one or more fibers 150, 160 seat. The cover 144 is movable relative to the base 142 between an open position and a closed position. For example, the cover 144 may pivot relative to the base 142 along a hinge axis H. In some example mounting clips the hinge axis H is located at a first side of the base 142 (e.g., a right-handed mounting clip) and in other example mounting clips the hinge axis H is located at an opposite second side of the base 142 (e.g., a left-handed mounting clip). In some examples, the cover 144 is held in the closed position by a magnet arrangement 148. In other examples, the cover 144 may latch or otherwise secure to the base 142 in the closed position.

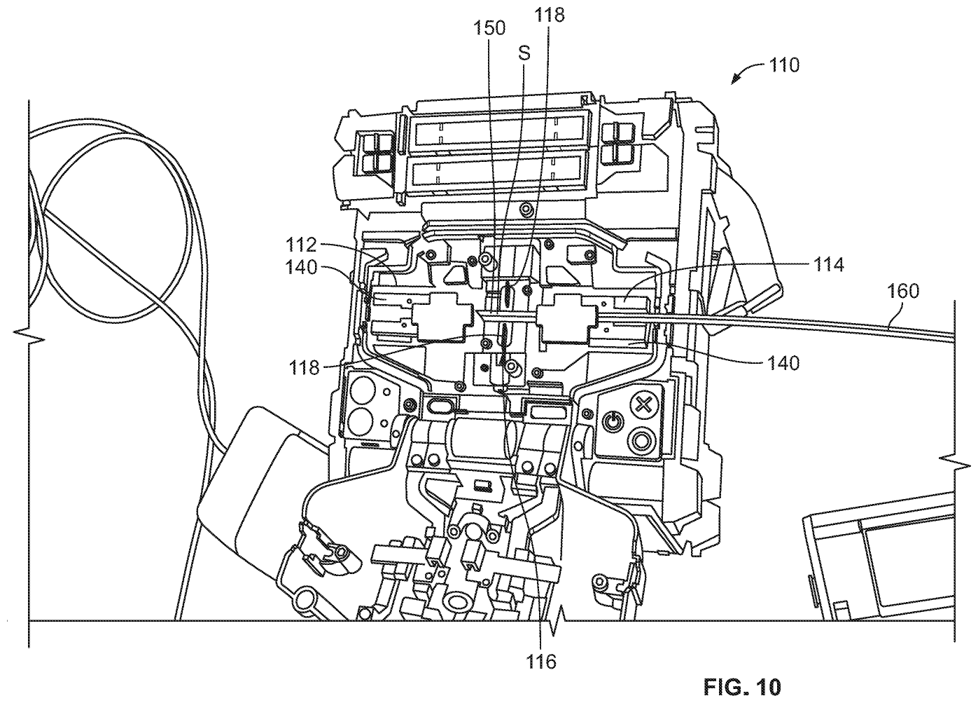

The mounting clip 140 is disposed on the set of fibers 150, 160 adjacent the end 152, 162 of the fibers to be terminated. The fibers 150, 160 extend past an end 146 of the clip 140 so that the ends 152, 162 to be terminated are offset from the mounting clip 140. Other ends of the fibers extend beyond the opposite end of the clip (e.g., see fibers 160 and clip 140 in FIG. 10). Prior to cleaving, the fibers 150, 160 extend beyond the clip end 146 by a greater distance than is desired for splicing or terminating the fibers 150, 160.

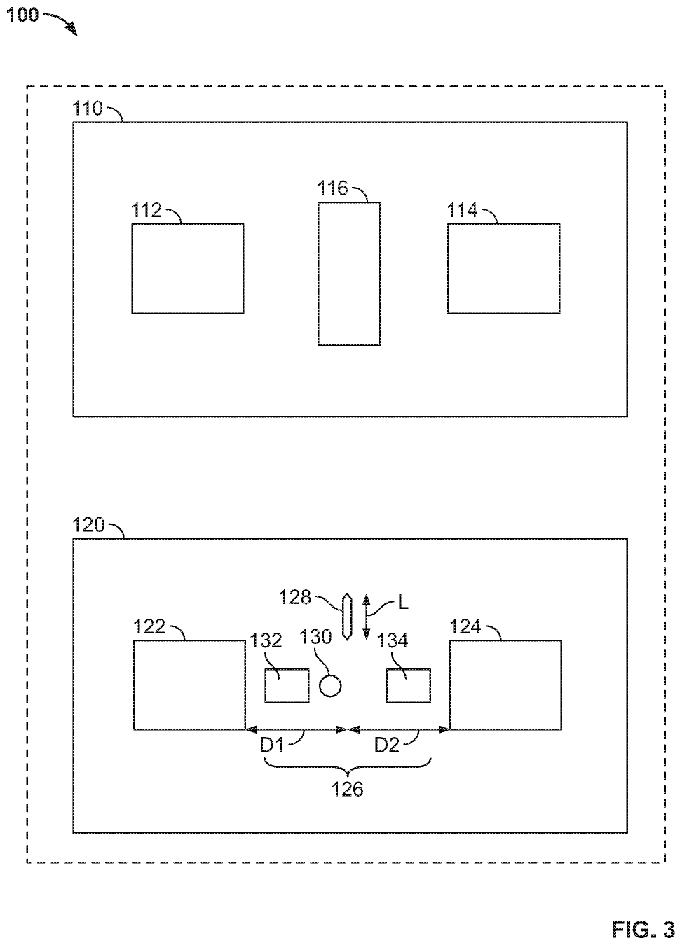

FIG. 3 shows an example workstation 100 including a splicing tool 110 and a cleaving tool 120 at which the mounting clip 140 can be used. The splicing tool 110 includes first and second mounting nests 112, 114 disposed at opposite ends of a splice region 116. In certain implementations, the splice region 116 includes fusion splice probes 118 for generating arc/plasma discharge to melt the cleaved ends of the first and second sets of fibers 150, 160 at a splice location S (see FIG. 10).

A first mounting clip 140 can be disposed at the first nest 112 to hold a first set of fibers 150 at the splicing tool 110 in a first orientation (e.g., with the fibers extending in a first direction) and a second mounting clip 140 can be disposed at the second nest 114 to hold a second set of fibers 160 at the splicing tool 110 in a second orientation (e.g., with the fibers extending in a second direction that is opposite the first direction). Accordingly, the first and second sets of fibers 150, 160 extend towards each other and both extend towards the splicing region 116. Each of the sets of fibers 150, 160 is cleaved prior to being disposed at the splicing tool 110.

As shown in FIG. 3, the cleaving tool 120 includes first and second mounting nests 122, 124 disposed at opposite ends of a cleave region 126. In some implementations, the cleave region 126 includes a flex cleaving arrangement. For example, the cleave region 126 may include a scorer 128 and an actuator 130. In the example shown, the cleave region 126 also includes pads 132, 134 disposed between the nests 122, 124. In other implementations, the cleave region 126 may include other types of cleavers, such as an axial cleaver that pulls the fibers apart after scoring.

In some implementations, the mounting nests 122, 124 of the cleaving tool 120 are positioned a common distance from the cleave region 126. For example, the mounting nests 122, 124 can be positioned at a common distance when the cleaving tool 120 is intended to cut both sets of fibers 150, 160 for splicing 110. In other implementations, the mounting nests 122, 124 may be positioned at different distances D1, D2, respectively, from the cleave region 126. Accordingly, the same cleaving tool 120 could be used to terminate fiber ends 152, 162 for at least two different applications having different fiber length requirements—fibers for the first application would be mounted at the first nest 122 and fibers for the second application would be mounted at the second nest 124. In an example, each mounting nest 122, 124 may be positioned a respective distance D1, D2 from the scorer 128 (or blade or other component) of the cleave region 126.

The cleaving tool 120 is configured to cleave the ends 152, 162 of both sets of fibers 150, 160 without the need to reorient the fibers between cleaving and splicing. The cleaving tool 120 is disposed relative to the splicing tool 110 so that the first nest 122 of the cleaving tool 120 faces in a common orientation with the first nest 112 of the splicing tool 110 and the second nest 124 of the cleaving tool 120 faces in a common orientation with the second nest 114 of the splicing tool 110. By allowing the fibers 150, 160 to mount at the cleaving tool 120 in the same orientation that they will mount at the splicing tool 110, fiber management that would otherwise be required during reorientation of the fibers 150, 160 is avoided. The efficiently with which the cleaved fibers can be transferred to the splicing tool 110 also is increased.

The first set of optical fibers 150 can be positioned at the cleaving tool 120 by inserting the first mounting clip 140 at the first nest 122. The fibers 150 extend from the first mounting clip 140 and across the cleave region 126 in a first direction O1 (see FIG. 5A). After the ends 152 of the fibers 150 are removed, the mounting clip 140 is removed from the first nest 122 of the cleaving tool 120 and moved to the first nest 112 of the splicing tool 110. In certain examples, the orientation of the first mounting clip 140 does not change during this transfer.

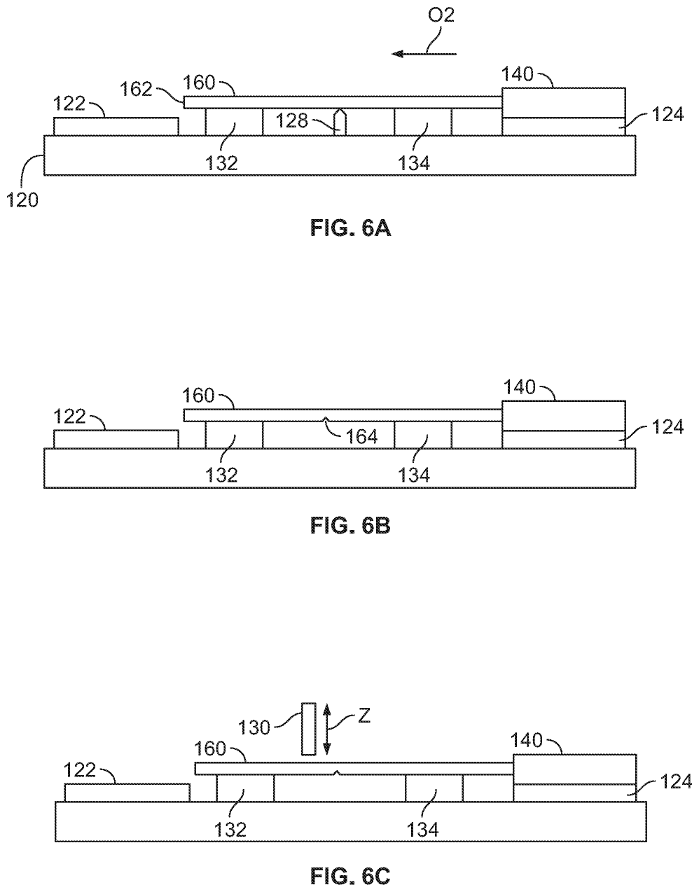

The second set of optical fibers 160 can be positioned at the cleaving tool 120 by inserting the second mounting clip 140 at the second nest 124. The fibers 160 extend from the second mounting clip 140 and across the cleave region 126 in a second direction O2 (FIG. 6A) that is opposite the first direction. After the ends 162 of the fibers 160 are removed, the second mounting clip 140 is removed from the second nest 124 of the cleaving tool 120 and moved to the second nest 114 of the splicing tool 110. In certain examples, the orientation of the second mounting clip 140 does not change during this transfer.

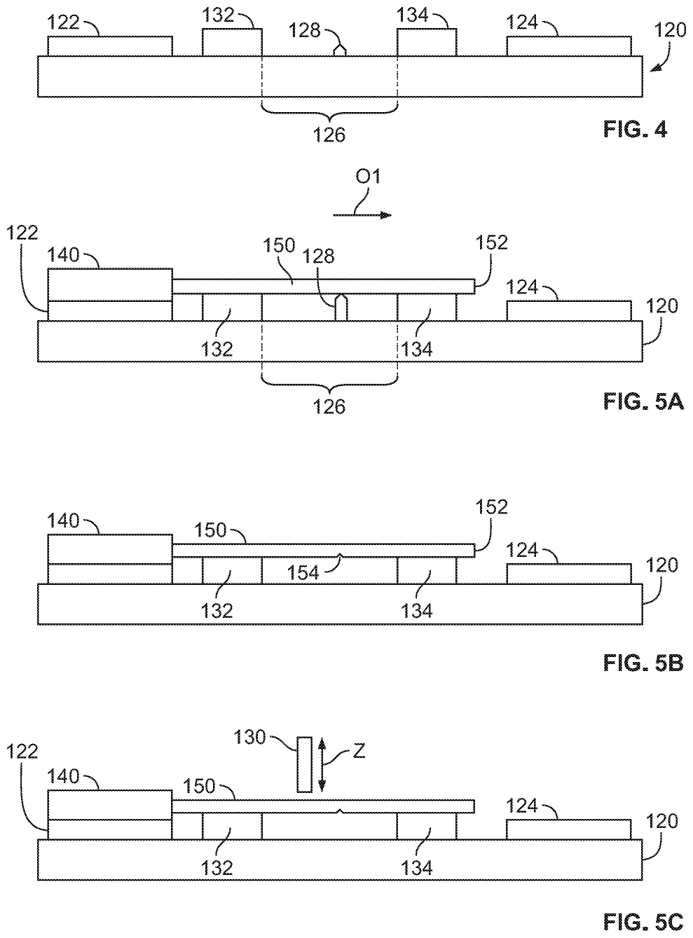

FIG. 4 is a front elevational view of an example cleaving tool 120. Between the first and second nests 122, 124, two pads or other support structures 132, 134 are disposed. A scoring tool 128 is disposed between the two pads 132, 134. An actuator 130 (see FIG. 5C) also is disposed between the two pads 132, 134. In some examples, the actuator 130 is a pneumatic actuator. In other examples, the actuator 130 is a hydraulic actuator, magnetic actuator, electro-mechanical actuator, etc.

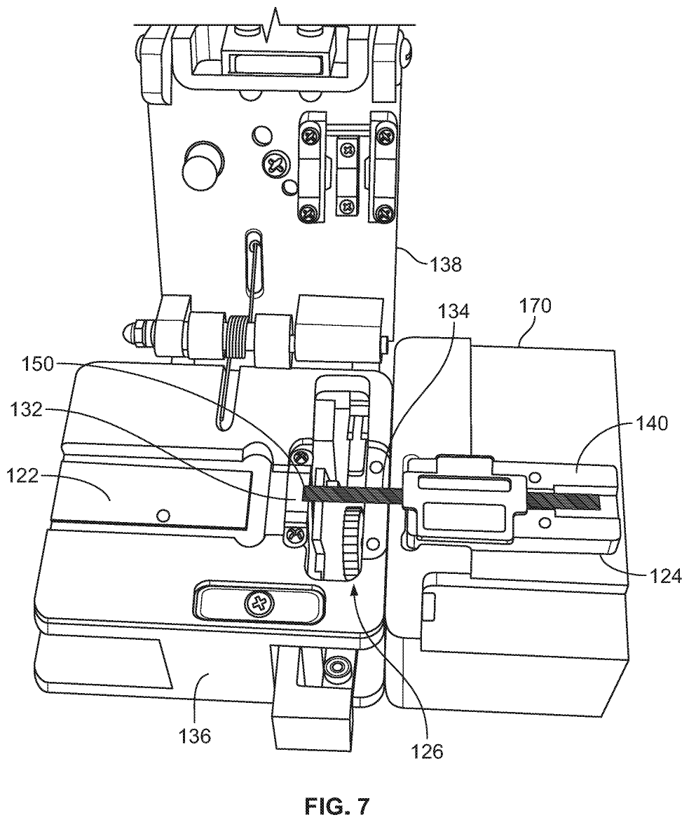

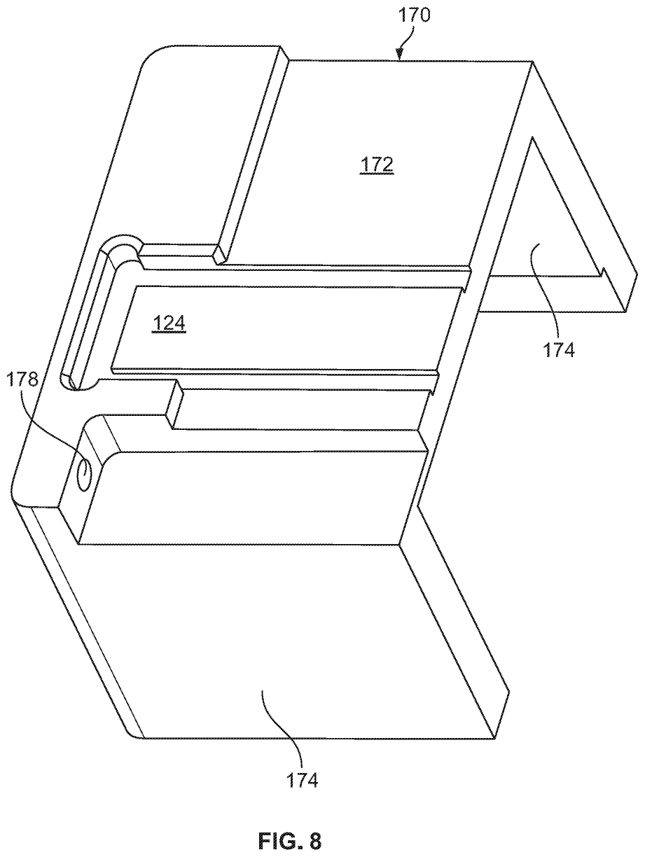

As shown in FIG. 7, the cleaving tool 120 includes a base 136 and a lid 138. The base 136 carries the first and second nests 122, 124, the pads 132, 134, and the scoring tool 128. The lid 138 carries the actuator 130. The lid 138 is movable relative to the base 136 between open and closed positions to selectively position the actuator 130 relative to the fibers 150, 160.

As shown in FIGS. 5A-5C, the first set of optical fibers 150 can be positioned at the cleaving tool 120 by placing the first mounting clip 140 in a recess or pocket at the first nest 122. The fibers 150 extend in the first direction 01 over the first pad 132, across the scoring tool 128, and at least partially over the second pad 134 (see

FIG. 5A). Since the fibers 150, 160 extend at least partially over both support pads 132, 134, only one set of optical fibers 150, 160 can be mounted to the cleaving tool 120 at one time.

During operation of the cleaving tool 120, the scoring tool 128 moves laterally across the set of one or more fibers 150 to scratch a score line 154 across the fiber(s) 150. The score line 154 defines a point of weakness for each fiber 150 of the first set. Accordingly, when the actuator 130 presses against the fiber(s) 150 between the score line 154 and one of the pads 132, 134, the fiber(s) 150 break at the score line 154. Accordingly, all fibers 150 in the first set are cut to the same length—the length D1 between the first mounting nest 122 and the scoring tool 128. The first mounting clip 140 is then removed from the cleaving tool 120. In some implementations, the first mounting clip 140 is transferred to the splicing tool 110. In other implementations, the first mounting clip 140 is transferred to a termination tool for inserting the cleaved ends into a plug connector or other such component.

As shown in FIGS. 6A-6C, the second set of optical fibers 160 can be positioned at the cleaving tool 120 by placing the second mounting clip 140 in a recess or pocket at the first nest 124. The fiber(s) 160 extend in the second direction O2 over the second pad 134, across the scoring tool 128, and at least partially over the first pad 132 (see FIG. 6A). During operation of the cleaving tool 120, the scoring tool 128 moves laterally across the second set of one or more fibers 160 to scratch a score line 164 across the fiber(s) 160. The score line 164 defines a point of weakness for each fiber 160 of the second set. Accordingly, when the actuator 130 presses against the fiber(s) 160 between the score line 164 and one of the pads 132, 134, the fiber(s) 160 break at the score line 164. Accordingly, all fibers 160 in the second set are cut to the same length—the length D2 between the second mounting nest 124 and the scoring tool 128. The second mounting clip 140 is then removed from the cleaving tool 120. In some implementations, the second mounting clip 140 is transferred to the splicing tool 110. In other implementations, the second mounting clip 140 is transferred to a termination tool for inserting the cleaved ends into a plug connector or other such component.

In certain examples, the scoring tool 128 and actuator 130 do not move relative to each other along the directions O1 and O2. Rather, the scoring tool 128 moves laterally L relative to the actuator 130 and nests 122, 124 (see FIG. 3). The actuator 130 moves along an upward-downward axis Z relative to the scoring tool 128 and nests 122, 124 (see FIGS. 5C and 6C). In the example shown, the actuator 130 is disposed between the first pad 132 and the scoring tool 128. Accordingly, regardless of whether the first or second set of fibers 150, 160 is mounted at the cleaving tool 120, the actuator 130 will press against the fibers 150, 160 between the first pad 132 and the score line 154, 164. However, when cleaving the first set of fibers 150, the actuator 130 presses against the fibers 150 at the mounting clip side of the score line 154 (see FIG. 5C) and when cleaving the second set of fibers 160, the actuator 130 presses against the fibers 160 at the opposite side of the score line 164 from the first mounting clip 140.

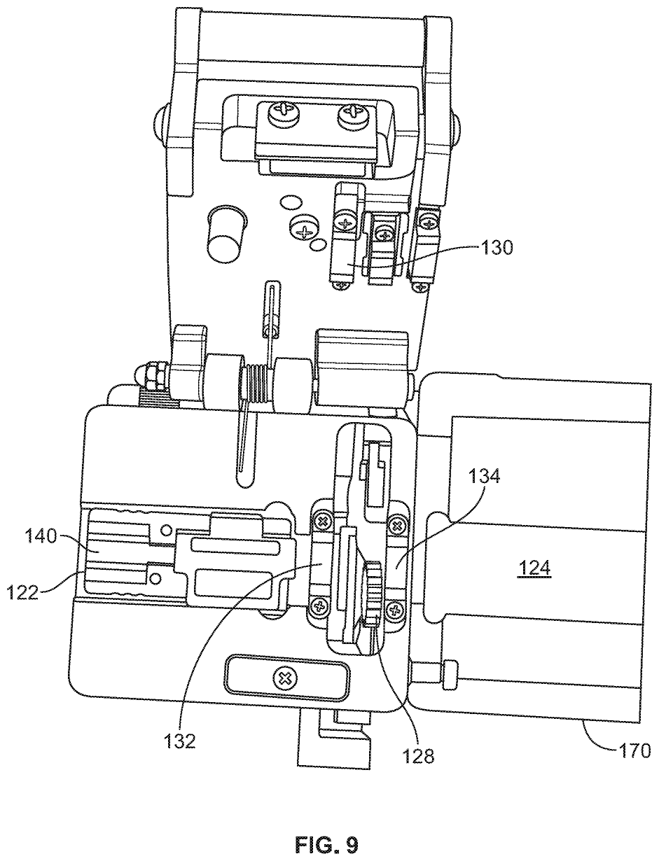

FIGS. 7-9 illustrate how an existing one-nest cleaving tool could be retro-fit to have two nests in accordance with the principles of the present disclosure. In the example shown, the second nest 124 is defined by an extension 170 that mounts to the standard cleaving tool. In the example shown, the standard cleaving tool defines the first nest 122, the first and second pads 132, 134, the scoring tool 128, and the actuator 130. The extension 170 can mount to the base 136 of the standard cleaving tool at an opposite side of the cleave region 126 from the first nest 122. The extension 170 is configured so that the second nest 124 aligns with the first nest 122. Accordingly, the second nest 124 also aligns with the first and second pads 132, 134, the scoring tool 128, and the actuator 130.

FIG. 8 shows an example extension 170 suitable for use with a standard cleave tool. The extension 170 includes a top surface 172 that defines the second nest 124 (e.g., defines a channel or pocket). The extension 170 also includes first and second legs or walls 174 that extend downwardly from the top surface 172 to support the top surface 172. In certain examples, the top surface 172 is defined by a platform extending between opposite legs or walls 174. In other examples, additional supports can be provided for the top surface 172. In certain implementations, the extension 170 defines apertures 178 or other coupling mechanism for attaching the extension 170 to the cleaving tool. In certain implementations, bolts or other fasteners may be inserted through the apertures 178 to secure the extension 170 to the cleaving tool.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A fiber cleaving tool extending along an axis between opposite first and second ends, the fiber cleaving tool comprising:
a first mounting nest configured to receive a first mounting clip holding a first optical fiber;
a second mounting nest aligned along the axis with the first mounting nest, the second mounting nest being configured to receive a second mounting clip holding a second optical fiber;
and
a cleaving component carried by the body at a cleaving region disposed between the first and second mounting nests.

2. The fiber cleaving tool of claim 1, wherein the cleaving component includes a flex cleaver.

3. The fiber cleaving tool of claim 2, wherein the flex cleaver includes a scoring tool to create a score line across the optical fiber and an actuator to flex the optical fiber sufficient to break the optical fiber at the score line.

4. The fiber cleaving tool of claim 3, wherein the scoring tool moves laterally across the optical fiber to create the score line and the actuator moves along an axis transverse to the lateral movement of the scoring tool.

5. The fiber cleaving tool of claim 3, wherein the cleaving region also includes first and second support pads disposed at opposite ends of the cleaving component, wherein the actuator presses against the optical fiber between the first and second support pads to break the optical fiber at the score line.

6. The fiber cleaving tool of claim 1, wherein each of the first and second nests is sized to hold the respective mounting clip when the mounting clip holds a plurality of optical fibers.

7. The fiber cleaving tool of claim 1, wherein each of the first and second nests is configured to hold the respective mounting clip in an orientation that directs the respective fibers towards the cleave region.

8. The fiber cleaving tool of claim 1, wherein the body includes a base and a lid that is movable relative to the base, the base carrying the first nest.

9. The fiber cleaving tool of claim 8, wherein the base carries the scoring tool and the lid carries the actuator.

10. The fiber cleaving tool of claim 1, wherein the first and second mounting nests are disposed a common distance from the cleaving component.

11. An extension component for use with a standard cleaving tool including a mounting nest and a cleaving component aligned along an axis, the extension component comprising:
a body defining a second mounting nest, the body being configured to mount to the standard cleaving tool such that the second mounting nest aligns with the mounting nest of the standard cleaving tool along the axis.

12. The extension component of claim 11, wherein the body defines fastener apertures for mounting the body to the standard cleaving tool.

13. The extension component of claim 11, wherein the second mounting nest defines an elongate pocket recessed into a top surface of the extension component.

14. A workstation for use in splicing together at least two optical fibers at a splice location, the workstation comprising:
a cleaving tool including first and second mounting nests disposed at opposite ends of a cleave region, the first mounting nest being configured to hold a first mounting clip in a first orientation, the second mounting nest being configured to hold a second mounting clip in a second orientation opposite the first orientation so that each of the mounting clips direct a respective set of one or more fibers towards the cleave region; and
a splicing tool including first and second mounting nests disposed at opposite ends of a splice region, the first mounting nest of the splicing tool being configured to hold the first mounting clip in the first orientation and the second mounting nest of the splicing tool being configured to hold the second mounting clip in the second orientation.

15. (canceled)

16. (canceled)

17. A method of preparing first and second sets of optical fibers for splicing, the method comprising:
attaching the first set of one or more optical fibers to a fiber cleaving tool in a first orientation, and cleaving the ends of the optical fibers of the first set;
transferring the first set of the optical fibers from the fiber cleaving tool to a splicing tool without altering the first orientation of the first set of optical fibers;
attaching the second set of one or more optical fibers to the fiber cleaving tool in a second orientation that is opposite the first orientation, and cleaving the ends of the optical fibers of the second set; and
transferring the second set of the optical fibers from the fiber cleaving tool to the splicing tool without altering the second orientation of the second set of optical fibers.

18. The method of claim 17, wherein attaching the first set of optical fibers to the fiber cleaving tool comprises positioning a first mounting clip holding the first set of one or more optical fibers at a first mounting nest defined by the fiber cleaving tool; and wherein attaching the second set of optical fibers to the second cleaving tool comprises positioning a second mounting clip holding the second set of one or more optical fibers at a second mounting nest defined by the fiber cleaving tool.

19. The method of claim 17, wherein either cleaving step includes scoring the optical fibers of the respective set and pushing an actuator against the optical fibers adjacent the score line.

20. The method of claim 17, wherein a common cleaving component is used to cleave the ends of the optical fibers of the first set and of the optical fibers of the second set.
